(19) United States
(12) Patent Application Publication
(10) Pub. No.: US 2026/0339281 A1
(43) Pub. Date: Oct. 29, 2026

(54) METHOD FOR MANUFACTURING A PACKAGING WELD

(71) Applicant: AISAPACK HOLDING SA, Vouvry (CH)

(72) Inventors: Fouad THELJANI, Monthey (CH); Stéphane EMERY, Lens (CH)

(21) Appl. No.: 19/118,234

(22) PCT Filed: Oct. 13, 2023
(86) PCT No.: PCT/IB2023/060347

§ 371 Date: Apr. 3, 2025

(30) Foreign Application Priority Data
Oct. 14, 2022 (EP) 22201756.8

(51) Int. Cl. G05B 13/04; B23K 31/12; B23K 101/18

(52) U.S. Cl. CPC G05B 13/041; B23K 31/125; B23K 2101/18

(57) ABSTRACT

The invention relates to a method for seam-welding a sheet, the method comprising a real-time self-adaptive regulation of the welding controls, based on in-line measurements of one or more characteristics of the weld.

### CORRESPONDING APPLICATIONS

The present PCT application claims priority to earlier European Patent application N° EP 22201756.8 filed on Oct. 14, 2022 in the name of AISAPACK HOLDING SA, the content of the earlier application being incorporated by reference in its entirety in the present PCT application.

### FIELD OF THE INVENTION

The invention relates to the field of the methods for manufacturing packages, and more particularly flexible packages manufactured by welding. The invention can be used for example to manufacture packaging tubes intended notably, but not exclusively, for the packaging of liquid or viscous or semiliquid products or even products in powder form.

Obviously, the invention is not limited to this single application of manufacturing packaging tubes, but can be applied to other fields in which the manufacturing of an object results from the welding of single-layer or multi-layer sheets for example made of plastic or of paper or of aluminium or a combination of these materials

### PRIOR ART

Publication WO2020049531, the content of which is incorporated by reference in the present application, describes a method and a device for seam-welding a sheet to make flexible packages. The method described in WO20202049531 incorporates the continuous “in line” measurement of the thickness of the weld which allows for a real-time checking of the weld quality of 100% of the packages produced, and any defective packages to be discarded from the production batch. This method offers many advantages but does however require the intervention of an operator to adjust the controls of the machine when quality deviations are observed. These deviations may devolve from variations in the environment of the production machine (temperature, humidity), variations of the components used on the machine (thickness of the sheet, humidity and temperature of the sheet), or devolve from the machine (overheating, wear).

The objective of the present invention is to remedy the above-mentioned drawbacks using a self-adaptive production method which regulates and/or adapts the welding controls (parameters) of the machine in real time based on measured characteristics of the weld. This method makes it possible to ensure a constant weld quality despite variations of the production environment, or variations of the sheet, or variations resulting from wear and/or overheating of the production machine and tools.

### GENERAL SUMMARY OF THE INVENTION

An aim of the invention is to improve the methods and devices for manufacturing welded packages, in particular packaging tubes intended notably, but not exclusively, for the packaging of liquid or viscous products.

Another aim is to propose a method and a device for self-adaptive welding which adjust, in real time, the controls thereof to obtain constant weld characteristics despite variations of the production environment, and/or despite variations of the properties of the welded components, and/or despite variations linked to the production equipment.

Another aim is to propose a welding method and device which make it possible to reduce the differences between the packages in a production batch.

Another aim is to propose a method and a device that can be implemented simply and efficiently.

Another aim is to propose modular methods and systems which can be implemented or added on existing machines.

Other aims and solutions devolving from the present invention will be described in the text hereinbelow and in the embodiments of the present invention.

To this end, the invention relates notably to a method for welding packages at a high rate of production.

The invention relates, on the one hand, to a method for seam-welding a sheet, at a high rate of production, and comprising a real-time self-adaptive regulation of the welding controls (parameters), based on in-line measurements of one or more characteristics of the world during production and without stopping the machine. The measured characteristics of the weld can be of dimensional nature, such as, for example, the thickness or the width of the welded zone; or of aesthetic nature such as, for example, the absence of visual defects, or even of structural nature such as, for example, its crystallinity, or the absence of defects such as air bubbles, cavities or degraded zones.

According to embodiments of the invention, it is the variation of these weld characteristics which is determined by comparison with reference characteristics.

The invention relates also to a method for welding and assembling a component on a tubular packaging body, said component being, for example, a tube head or a flask neck, or a flask bottom. According to the invention, the welding method can be performed at a high rate of production and comprises a real-time self-adaptive regulation of the welding controls (parameters), based on in-line measurements of one or more weld characteristics during production and without stopping the machine. The measured characteristics of the weld are, for example, its temperature, its aesthetic appearance, its compression ratio, its width or any other measurement characteristic of the weld which could be relevant in the context of the present invention.

An aim of the invention is notably to produce welds that are “constant” by measuring in real time the chosen characteristic(s) of the weld and by performing in real time a self-adaptive regulation of the welding controls and/or parameters.

As will be understood from the nonlimiting examples, the principle of the invention can be applied to any welded zone or weld of the product or object concerned.

The various means (regulation process, concrete measurements, means involved, models) and their embodiments used in the context of the present invention are described hereinbelow.

According to embodiments, the invention concerns a method for seam-welding a sheet, said method comprising a real-time self-adaptive regulation of the welding controls, based on in-line measurements of one or more characteristics of the weld.

In embodiments, the method comprises a digital model with self-adjustable parameters which simulates the behaviour of the welding device and adjusts said parameters in real time.

In embodiments, the measured characteristics of the weld are of dimensional nature, such as for example the thickness or the width of the welded zone, or of aesthetic nature such as for example the absence of visual defects, or even of structural nature, such as for example its crystallinity, or the absence of defects such as air bubbles, cavities or degraded zones.

In embodiments, the self-adaptive regulation is performed on the weld heating controls and/or on the weld pressurising controls, and/or on the weld cooling controls and/or on the weld reforming controls, and/or on some or all of the heating, compression, cooling and reforming controls and/or by minimising the energy used to perform the welding operation without modifying the characteristics of the weld.

In embodiments, at least one characteristic of the weld measured in real time is used to regulate the welding method, said characteristic being the thickness of the weld and/or the aesthetic appearance of the weld, and/or the width of the weld and/or a distance between barrier layers, and/or the creep length of the material pressurised at the weld and/or the temperature at the weld, and/or the rate of crystallinity of the weld and/or characteristics of the sheet, such as its thickness, and/or of the machine, such as the welding energy.

In embodiments, means that are mechanical, and/or optical, and/or electromagnetic with a wave reflected by the weld and/or passing through the weld and/or absorbed by the weld, and/or by ultrasounds, and/or laser, and/or infrared, and/or tomography are used as measurement means.

In embodiments, a self-adjustable digital model which is a state model, and/or a transfer function, and/or a digital twin is used.

In embodiments, the parameters of the model are adjusted in real time by minimising the deviation between the response (to an identical control) of the method and that of the model and/or the adjustment of the parameters of the model is performed by an RLS (Recursive Least Square) incremental algorithm, and/or the adjustment of the parameters of the model is performed by quadratic optimisation (quadratic programming) and/or the self-adjusted parameters of the model are used by a synthesis computer which adjusts in real time the parameters of the multivariable control regulator.

In embodiments, a regulator adjusts in real time the control of the welding method based on the difference between the desired characteristics and the measured characteristics of the weld and with the self-adjusted parameters transmitted by the self-adaptive modelling module, wherein the regulator is of PID (Proportional, Integrator, Derivator) type and/or the regulator is of LQR (Linear Quadratic Regulator) type and/or the control is single-variable with single input-single output, or the control is multivariable with multiple inputs-single output, or the control is multivariable with multiple inputs multiple outputs.

In embodiments, the invention concerns a device for implementing the method as described herein, said device comprising a self-adjustment loop of the welding control and a self-adaptive modelling module.

In embodiments, the self-adjustment loop comprises a regulator.

In embodiments, the self-adaptive modelling module comprises a self-adjustable digital model determining the optimal parameters of the model and a synthesis computer which determines the adjusted parameters of the regulator and transmits them to said regulator.

In embodiments, the system used to carry out the measurements is the one disclosed in WO2020049531 mentioned above and incorporated by reference in the present application.

Other embodiments and features of the invention are detailed in the following description.

### DETAILED DESCRIPTION OF THE INVENTION

FIG. 1 illustrates the principle of the method according to the invention.

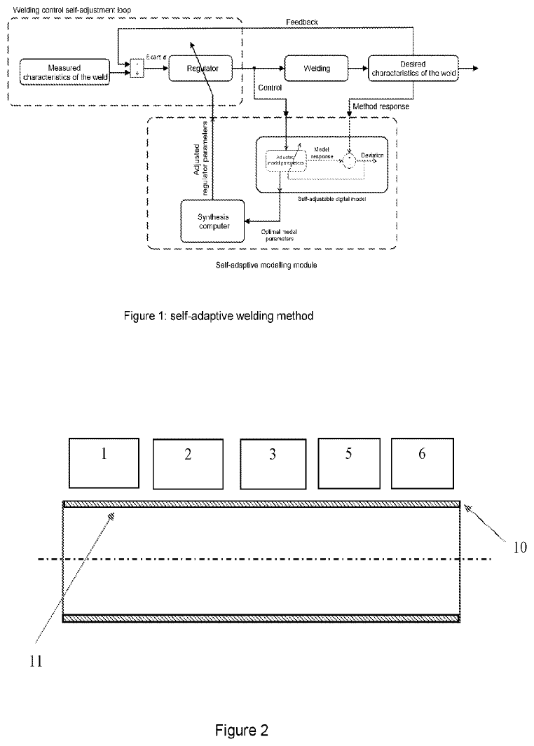

FIGS. 2 to 4 schematically illustrate means and devices used to implement the method according to embodiments of the invention.

According to the invention's principle, the desired characteristics of the weld are, on the one hand, entered into a comparator. On the other hand, and by a feedback loop, the measured characteristics of the weld are also entered into the comparator and the deviation between the desired values and the measured values is determined (“Deviation e”). This deviation is entered into a regulator to determine the control thereof.

The control of the regulator is then used to control the machine, namely to execute the controls necessary to perform the desired welding: examples of possible controls are described in the present application and in the non-limiting Examples 1 to 3 hereinbelow. Following the welding operation, the measured characteristics of the weld are determined on a produced object and these characteristics are entered into the feedback loop on the comparator situated upstream of the regulator to calculate the deviation “Deviation e”.

On the other hand, the regulator control is also entered into a self-adjusted digital model module. This model “models” the real behaviour of the system and is self-adjustable to this behaviour (that is to say that it takes account of the modifications occurring in reality). The response of the model to this control is compared to the response of the actual method, that is to say to the measured characteristics of the weld. The parameters of the model are then adjusted to minimise this deviation (or even cancel it) and the adjusted parameters resulting from this minimisation are considered to be the optimal parameters of the model. Said optimal parameters of the model are then used in a synthesis computer to determine adjusted parameters of the regulator which are then injected into the regulator. Since the system has a certain inertia, a given control (for example a control to increase heating) will have no immediate effect on the welds obtained and therefore on the measured characteristics. To avoid an oscillation of the system devolving from the delay (or offset-in-time) in the effect of the control with respect to the control itself, it is necessary to use such a regulator which takes account of this offset and anticipates it in its control given to the system.

The “Deviation e” parameter in the welding control loop makes it possible to take account of changes in the method. As long as the deviation is not zero (or the measured deviation is not within a predetermined acceptable value range), the process of adjusting the parameters of the regulator continues as described hereinbelow with the self-adaptive model. As soon as the measured deviation “Deviation e” is zero (or within a predetermined acceptable range), this then means that the optimal parameters of the regulator have been reached; these parameters are kept set by ceasing to adjust them. Obviously, if a deviation is once again measured between the desired characteristics and those that are measured, the adjustment process described hereinabove is restarted, automatically or not.

The system can thus adust the control of the regulator with respect to the measured characteristics, self-adapt the model to optimise it and use the optimal parameters in the regulator so that the latter generates the appropriate control.

The various regulation, control and measurement parameters, like the models, are described hereinbelow.

### Self-Adaptive Regulation of the Welding Controls

According to embodiments of the invention, a self-adaptive regulation of the weld pre-heating controls is performed.

According to embodiments of the invention, a self-adaptive regulation of the weld heating controls is performed.

According to embodiments of the invention, a self-adaptive regulation of the weld pressurising controls is performed.

According to embodiments of the invention, a self-adaptive regulation of the weld cooling controls is performed.

According to embodiments of the invention, a self-adaptive regulation of the weld annealing controls is performed.

According to embodiments of the invention, a self-adaptive regulation of the weld reforming controls is performed.

According to embodiments of the invention, a self-adaptive regulation of some or all of the heating, compression, cooling and reforming controls is performed.

According to embodiments of the invention, the self-adaptive regulation of the welding method minimises the energy used to perform the welding operation without modifying the characteristics of the weld.

### Characteristics of the Weld

According to the invention, at least one characteristic of the weld measured in real time is used to regulate the welding method. Possible measuring means are defined hereunder in the description.

According to embodiments of the invention, at least the thickness of the weld is used as characteristic to regulate the welding method.

According to embodiments of the invention, at least the aesthetic appearance of the weld is used as characteristic to regulate the welding method. For example the appearance criteria may be the absence of visual or strucural defects, such as for example the crystallinity, or the absence of defects such as air bubbles, cavities or degraded zones. Other criteria may be used.

According to embodiments of the invention, at least the width of the weld is used as characteristic to regulate the welding method.

According to embodiments of the invention, at least the distance between the barrier layers of the sheet is used as characteristic to regulate the welding method.

According to embodiments of the invention, at least the length of creep of the material pressurised at the weld is used as characteristic to regulate the welding method.

According to embodiments of the invention, at least the temperature at the weld is used as characteristic to regulate the welding method.

According to embodiments of the invention, at least the rate of crystallinity of the weld is used as characteristic to regulate the welding method.

According to embodiments of the invention, at least the rate of leakage of a gas (such as helium, nitrogen, oxygen or air) from the weld is used as characteristic to regulate the welding method.

According to embodiments of the invention, the thickness of the weld and the aesthetic appearance of the weld are used as characteristics to regulate the welding method.

According to embodiments of the invention, characteristics of the welded components measured in real time are used also to regulate the welding method.

According to embodiments of the invention, characteristics of the sheet measured in real time are used also to regulate the welding method.

According to embodiments of the invention, the thickness of the weld and the thickness of the sheet are used as characteristics to regulate the welding method.

According to embodiments of the invention, characteristics of the machine measured in real time are used also to regulate the welding method.

According to embodiments of the invention, the aesthetic appearance of the weld and the welding energy are used as characteristics to regulate the welding method.

### Means for Measuring Characteristics of the Weld as Defined Herein

According to embodiments of the invention, a mechanical element is used to measure in real time characteristics of the weld.

According to embodiments of the invention, optical means are used to measure in real time characteristics of the weld.

According to embodiments of the invention, the optical means are an optical camera.

According to embodiments of the invention, an electromagnetic wave is used to measure in real time characteristics of the weld.

According to embodiments of the invention, the electromagnetic wave transmitted through the weld is used to measure in real time characteristics of the weld.

According to embodiments of the invention, the electromagnetic wave reflected by the weld is used to measure in real time characteristics of the weld.

According to embodiments of the invention, the absorbed electromagnetic wave is used to measure in real time characteristics of the weld.

According to embodiments of the invention, terahertz waves are used to measure in real time characteristics of the weld.

According to embodiments of the invention, ultrasounds are used to measure in real time characteristics of the weld.

According to embodiments of the invention, a laser radiation is used to measure in real time characteristics of the weld.

According to embodiments of the invention, an infrared radiation is used to measure in real time characteristics of the weld.

According to embodiments of the invention, an infrared camera is used to measure in real time characteristics of the weld.

According to embodiments of the invention, optical coherence tomography (OCT) is used to measure in real time characteristics of the weld.

According to embodiments of the invention, a leak detector is used to measure in real time characteristics of the weld.

### Digital Models

According to the invention, a self-adaptive modelling module comprising a self-adjustable digital model is used to regulate the method.

According to embodiments of the invention, the self-adjustable digital model is a state model.

According to embodiments of the invention, the self-adjustable digital model is a transfer function.

According to embodiments of the invention, the self-adjustable digital model is a neural network digital twin.

### Methods for Adjusting Parameters of the Model in Real Time

According to embodiments of the invention, the parameters of the model are adjusted in real time by minimising the deviation between the response (to an identical control) of the method and that of the model.

According to embodiments of the invention, the adjustment of the parameters of the model is performed by an RLS (Recursive Least Square) incremental algorithm.

According to embodiments of the invention, the adjustment of the parameters of the model is performed by quadratic optimisation (quadratic programming).

According to embodiments of the invention, the self-adjusted parameters of the model are used by a synthesis computer which adjusts in real time the parameters of the multivariable control regulator.

### Regulator

According to embodiments of the invention, the regulator adjusts in real time the control of the welding method based on the difference between the desired characteristics and the measured characteristics of the weld and with the self-adjusted parameters transmitted by the self-adaptive modelling module.

According to embodiments of the invention, the regulator is of a PID (Proportional, Integrator, Derivator) type.

According to embodiments of the invention, the regulator is of a LQR (Linear Quadratic Regulator) type.

According to embodiments of the invention, the control is single-variable with single input-single output.

According to embodiments of the invention, the control is multivariable with multiple inputs-single output.

According to embodiments of the invention, the control is multivariable with multiple inputs-multiple outputs.

### Examples of Methods According to the Invention Example 1 (see FIG. 2)

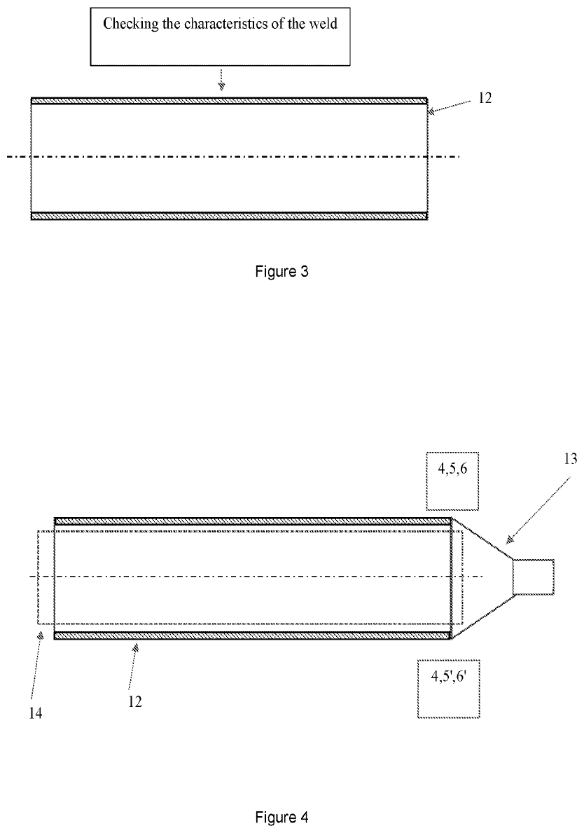

Example 1 of the welding method notably comprises the following steps:
Unwinding of a sheet (printed or not), for example from a reel;
Cutting of the sheet to a required width;
Shaping of the cut sheet in a tubular form 10;
Positioning of the ends 11 of the sheet to be welded together;
Heating of the ends to be welded 11 via a first heating element 1, the power control of which is self-adjusted in real time;
Heating of the ends to be welded via a second heating element 2, the power control of which is self-adjusted in real time;
Heating of the ends to be welded via a third heating element 3, the power control of which is self-adjusted in real time;
Pressing of the weld with a pressing tool 5;
Cooling with a cooling tool 6;
Reforming;
Checking the characteristics of the weld (FIG. 3) such as for example measuring of the thickness of the weld;
Self-adjustment loop of the welding control based on the characteristic of the weld measured according to the principles illustrated in FIG. 1;
Cutting of the tube 12 to a predetermined length to obtain tubular bodies, printed or not.

Self-adjusted controls of the method of Example 1:
Heating element 1 heating power;
Heating element 2 heating power;
Heating element 3 heating power;

Characteristic of the weld used to regulate the method of Example 1:
For example thickness of the weld.

### Example 2 (FIG. 4)

Example 2 of the welding method notably comprises the following steps:
Loading of a tube head 13 on a mandrel 14;
Loading of a tubular body 12 (for example as obtained in Example 1) on said mandrel 14;
Precise positioning of the end to be welded of the tubular body 12 with respect to the tube head 13;
Heating of the zone to be welded via a heating element 4, of which:
   The temperature of the heating means (for example hot air) is self-adjusted in real time;
   The flowrate of hot air is self-adjusted in real time;
   The blowing time of the hot air is self-adjusted in real time;
Pressing and cooling of the welded zone via a pressurising tool 5 and cooling tool 6;
Measuring of the temperature and of the aesthetic appearance of the weld as well as the welding energy;
Self-adjustment loop of the welding control based on the temperature of the weld, the aesthetic appearance of the weld and the energy measured according to the principles illustrated in FIG. 1 applied to FIG. 4.

Self-adjusted controls of the method of Example 2:
Air temperature of the heating element 4;
Air flow rate of the heating element 4;
Heating time of the heating element 4.

Characteristics of the weld used to regulate the method of Example 2:
Temperature of the weld;
Aesthetic appearance of the weld;
Energy.

### Example 3

Example 3 of the welding method notably comprises the following steps:
Unwinding of a sheet (printed or not), for example from a reel;
Cutting of the sheet to a required width;
Shaping of the cut sheet in a tubular form 10;
Positioning of the ends 11 to be welded together;
Driving of the ends to be welded via a first process belt, the torque control of which is self-adjusted in real time;
Driving of the ends to be welded via a second process belt, the torque control of which is self-adjusted in real time;
Heating of the ends 11 to be welded via the heating element 1, the power control of which is self-adjusted in real time;
Heating of the ends 11 to be welded via the heating element 2, the power control of which is self-adjusted in real time;
Pressing of the ends 11 to be welded via a first pressurising tool 5, the control of which is self-adjusted in real time;
Pressing of the ends 11 to be welded via a second pressurising tool 5′, the control of which is self-adjusted in real time;
Cooling of the weld via a first cooling tool 6, the temperature control of which is self-adjusted in real time;
Cooling of the weld via a second cooling tool 6′, the temperature control of which is self-adjusted in real time;
Reforming of the tube via a reforming element, the pressure control of which is self-adjusted in real time;
Measuring of the thickness and of the aesthetic appearance of the weld as well as the welding energy;
Cutting of the tube to a predetermined length to obtain a printed tubular body 12;
Measuring of the roundness of the tubular body 12;
Self-adjustment loop of the welding controls based on the thickness of the weld, the aesthetic appearance of the weld, the welding energy and the roundness of the tubular body 12 measured according to the principles illustrated in FIG. 1.

Self-adjusted controls of the method of Example 3:
Heating element 1 heating power;
Heating element 2 heating power;
Pressure of the first pressurising tool 5;
Pressure of the second pressurising tool 5′;
Temperature of the first cooling tool 6;
Temperature of the second cooling tool 6′;
Pressure of the reforming element.

Characteristics of the weld used to regulate the method of Example 3:
Thickness of the weld;
Aesthetic appearance of the weld;
Roundness of the tubular body 12;
Energy.

Process belts for driving ends of a sheet to be welded are known in the art, and for example are disclosed in WO2021014241, the content of this publication being incorporated by reference in its entirety in the present application.

In all embodiments, the pressing operation may be carried out while heating the ends to be welded, and/or while welding, and/or after heating or welding and/or while cooling or at another appropriate moment in the process.

### Advantages of the Invention

According to some the principles of the invention, the checking of certain characteristics of the weld makes it possible to ensure the quality of said weld. Since the checking is done continuously during production, the setting controls of the method are adapted automatically and in real time when the weld departs from the desired characteristics, or when a drift of other characteristics (consumed energy for example) is measured. The principle of the invention is very advantageous economically since it avoids scrapping and limits human intervention by virtue of a real-time self-regulation of the machine as soon as a drift is detected and before the appearance of a defect. The embodiments described in the present application are so described by way of illustrative examples and should not be considered to be limiting. Other embodiments may involve means equivalent to those described for example. The different embodiments described above can also be combined with one another according to the circumstances, or means used in one embodiment can be used in another embodiment.

Exemplary embodiments have been described to provide an overall understanding of the principles of the structure, function, manufacture, and use of the systems and methods disclosed herein. One or more examples of these embodiments are illustrated in the accompanying drawings. Those skilled in the art will understand that the systems and methods specifically described herein and illustrated in the accompanying drawings are non-limiting exemplary embodiments and that the scope of the present invention is defined not solely by the claims. The features illustrated or described in connection with one exemplary embodiment may be combined with the features of other embodiments. Such modifications and variations are intended to be included within the scope of the present invention. A number of problems with conventional methods and systems are noted herein and the methods and systems disclosed herein may address one or more of these problems. By describing these problems, no admission as to their knowledge in the art is intended. A person having ordinary skill in the art will appreciate that, although certain methods and systems are described herein with several non-limiting embodiments, the scope of the present invention is not so limited. Moreover, while this invention has been described in conjunction with a number of embodiments, it is evident that many alternatives, modifications and variations would be or are apparent to those of ordinary skill in the applicable arts. Accordingly, it is intended to embrace and cover all such alternatives, modifications, equivalents and variations that are within the spirit and scope of this invention.

1. A method for seam-welding a sheet, said method comprising a real-time self-adaptive regulation of the welding controls, based on in-line measurements of one or more characteristics of the weld.

2. The method according to claim 1, comprising a digital model with self-adjustable parameters which simulates the behaviour of the welding device and adjusts said parameters in real time.

3. The method according to claim 1, wherein the measured characteristics of the weld are of dimensional nature, such as for example the thickness or the width of the welded zone, or of aesthetic nature such as for example the absence of visual and/or structural defects, such as for example its crystallinity, or the absence of defects such as air bubbles, cavities or degraded zones.

4. The method according to claim 1, wherein the self-adaptive regulation is performed on the weld heating controls and/or on the weld pressurising controls, and/or on the weld cooling controls and/or on the weld reforming controls, and/or on some or all of the heating, compression, cooling and reforming controls and/or by minimising the energy used to perform the welding operation without modifying the characteristics of the weld.

5. The method according to claim 1, wherein at least one characteristic of the weld measured in real time is used to regulate the welding method, said characteristic being the thickness of the weld and/or the aesthetic appearance of the weld, and/or the width of the weld and/or a distance between barrier layers, and/or the creep length of the material pressurised at the weld and/or the temperature at the weld, and/or the rate of crystallinity of the weld and/or characteristics of the sheet, such as its thickness, and/or of the machine, such as the welding energy.

6. The method according to claim 1, wherein means that are mechanical, and/or optical, and/or electromagnetic with a wave reflected by the weld and/or passing through the weld and/or absorbed by the weld, and/or by ultrasounds, and/or laser, and/or infrared, and/or tomography are used as measurement means.

7. The method according to claim 1, wherein a self-adjustable digital model which is a state model, and/or a transfer function, and/or a digital twin is used.

8. The method according claim 1, wherein the parameters of the model are adjusted in real time by minimising the deviation between the response (to an identical control) of the method and that of the model and/or the adjustment of the parameters of the model is performed by an RLS (Recursive Least Square) incremental algorithm, and/or the adjustment of the parameters of the model is performed by quadratic optimisation (quadratic programming) and/or the self-adjusted parameters of the model are used by a synthesis computer which adjusts in real time the parameters of the multivariable control regulator.

9. The method according to claim 1, wherein a regulator adjusts in real time the control of the welding method based on the difference between the desired characteristics and the measured characteristics of the weld and with the self-adjusted parameters transmitted by the self-adaptive modelling module, wherein the regulator is of PID (Proportional, Integrator, Derivator) type and/or the regulator is of LOR (Linear Quadratic Regulator) type and/or the control is single-variable with single input—single output, or the control is multivariable with multiple inputs-single output, or the control is multivariable with multiple inputs-multiple outputs.

10. A device for implementing the method according to claim 1, said device comprising a self-adjustment loop of the welding control and a self-adaptive modelling module.

11. The device according to claim 10, wherein the self-adjustment loop comprises a regulator.

12. The device according claim 10, wherein the self-adaptive modelling module comprises a self-adjustable digital model determining the optimal parameters of the model and a synthesis computer which determines the adjusted parameters of the regulator and transmits them to said regulator.
